(19) United States
(12) Patent Application Publication
(10) Pub. No.: US 2026/0071469 A1
(43) Pub. Date: Mar. 12, 2026

(54) MOTOR VEHICLE LOCK

(71) Applicant: Brose Schließsysteme GmbH & Co. Kommanditgesellschaft, Wuppertal (DE)

(72) Inventors: Ludger GRAUTE, Essen (DE); Thomas KLEMMSTEIN, Mönchengladbach (DE); Carsten BRUCHSTEINER, Witten (DE)

(21) Appl. No.: 19/326,191

(22) Filed: Sep. 11, 2025

(30) Foreign Application Priority Data
Sep. 11, 2024 (DE) 102024126122.6

(51) Int. Cl. E05B 81/06; E05B 81/36; E05B 81/90

(52) U.S. Cl. CPC E05B 81/06; E05B 81/36; E05B 81/90

(57) ABSTRACT

The present invention relates to a motor vehicle lock with a lock latch and with a pawl system, wherein the lock latch can be adjusted into a closed position for the holding engagement with a locking part and into an open position for releasing the locking part, wherein, in a catching state, the pawl system locks the lock latch located in the closed position via a pawl against an adjustment in its opening direction and releases it in a lifting state, wherein an opening drive is provided, which brings the pawl system into the lifting state by means of a pivotable actuating element, by an electric drive motor of the opening drive pivoting the actuating element in a lifting direction from an initial position to an end position.

### CROSS-REFERENCE TO RELATED APPLICATION

This application claims priority pursuant to 35 U.S. C. 119(a) to German Application No. 102024126122.6, filed Sep. 11, 2024, which application is incorporated herein by reference in its entirety.

### FIELD OF THE INVENTION

The present invention relates generally to motor vehicle locks.

### BACKGROUND

The motor vehicle lock in question is used for all types of locking elements of a motor vehicle. These include locking elements such as side doors, rear doors, tailgates, trunk lids, hoods, and the like. These locking elements can generally be designed as swing or sliding doors.

DE 102 51 382 A1, on which the invention is based, relates to a motor vehicle lock that has a lock latch and a pawl as locking elements. The lock latch can be brought into a locking position in which it is in holding engagement with a locking part and in which it is fixed by the pawl. The motor vehicle lock has an opening drive with an electric drive motor with which the pawl can be lifted so that the lock latch can be adjusted to its open position, releasing the locking part.

### SUMMARY

The present invention relates to a motor vehicle lock with a lock latch and with a pawl system, wherein the lock latch can be adjusted into a closed position for the holding engagement with a locking part and into an open position for releasing the locking part, wherein, in a catching state, the pawl system locks the lock latch located in the closed position via a pawl against an adjustment in its opening direction and releases it in a lifting state, wherein an opening drive is provided, which brings the pawl system into the lifting state by means of a pivotable actuating element, by an electric drive motor of the opening drive pivoting the actuating element in a lifting direction from an initial position to an end position. It is proposed that the actuating element is associated with an actuating element spring, which spring-loads the actuating element located in the initial position counter to the lifting direction, and which spring-loads the actuating element located in the end position in the lifting direction.

In an emergency operation, the known motor vehicle lock provides for the pawl to be adjusted to the lifting state by means of a second opening drive. The second opening drive is designed to be self-locking via a gear train, which allows the pawl to be held automatically in the lifting state. This prevents the motor vehicle lock from locking again, so that the locking element can always be opened in emergency operation. However, the use of a second opening drive and the gear train requires a comparatively complex design of the motor vehicle lock.

The invention is based on the problem of designing and developing a generic motor vehicle lock in a way that allows the motor vehicle lock to be kept open in a structurally simple manner.

The above problem is solved by the features of Claim 1.

The fundamental consideration is to provide spring-loaded and preferably self-holding positions of an actuating element, which transmits the drive movement to the pawl. This allows the functional positions of the actuating element and thus the state of the pawl system to be defined mechanically in a simple manner.

In detail, it is proposed that an actuating element spring is associated with the actuating element, which spring-loads the actuating element in the initial position counter to the lifting direction and which spring-loads the actuating element in the end position in the lifting direction.

The spring load on the actuating element in the end position is preferably used to hold the pawl system in the lifting state, thereby keeping the motor vehicle lock open (Claim 2).

Preferably, provision is also made for securing an abutment of the actuating element against at least one stop, in particular at least in the initial position, according to Claim 3. The actuating element can thus be mechanically secured to prevent rattling noises.

The proposed solution is particularly interesting for an actuating element that is indirectly spring-loaded into the initial position according to Claim 4. The functional chain between the drive motor and the pawl can therefore be equipped with a return spring, but its effect is absorbed by the actuating element spring in the end position of the actuating element, so that the pawl system is held in the lifting state.

The particularly preferred embodiments according to Claims 6 and 7 relate to the implementation of the actuating element spring, which can be provided as a leg spring with a catching bevel for the end position. This means that the proposed solution can be realized with little design effort by simply modifying the shape of a leg spring.

The lifting of the pawl system is preferably affected via a release lever according to Claim 8, which is coupled in a rotationally fixed manner to the actuating element or is formed by the actuating element. Accordingly, the positions of the actuating element can be directly converted into the respective states of the pawl system.

The preferred embodiments according to Claims 9 and 10 relate to variants of the pawl system, which has a pawl lever for supporting the pawl. Holding the pawl system in the lifting state can thus be easily affected via the actuating element.

Claims 11 and 12 relate to a predetermined holding condition. Holding carried out in an emergency mode, wherein an energy storage device is provided for an opening drive, is particularly advantageous. The energy storage device ensures that at least one opening movement can be performed even in the event of a failure of the on-board electrical system, wherein the motor vehicle lock is deactivated to prevent an operator from being locked in, in particular before the energy storage device is further discharged. A further advantageous functionality is the realization of a memory function, which prevents the motor vehicle lock from locking prematurely, for example, in the event of snow load.

### BRIEF DESCRIPTION OF THE DRAWINGS

In the following, the invention is explained in more detail with reference to a drawing that merely represents exemplary embodiments. In the drawings

FIG. 1a shows a motor vehicle door with a motor vehicle lock according to the proposal in a perspective view;

FIG. 1b shows a motor vehicle lock according to the proposal in a perspective view;

FIG. 2a shows the motor vehicle lock with the actuating element in the initial position;

FIG. 2b shows the motor vehicle lock with the actuating element in the initial position;

FIG. 2c shows the motor vehicle lock with the actuating element in the end position; and,

FIG. 2d shows the motor vehicle lock with the actuating element in the end position.

### DETAILED DESCRIPTION OF THE INVENTION

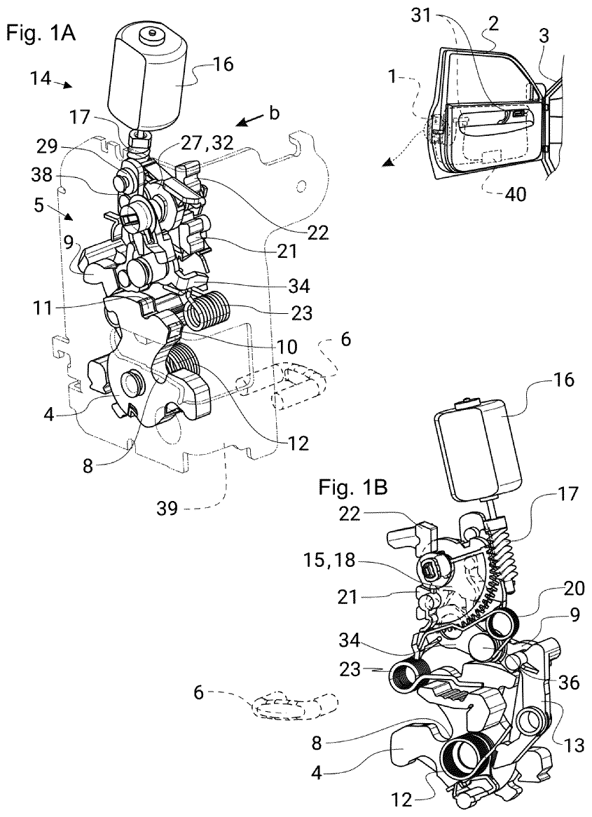

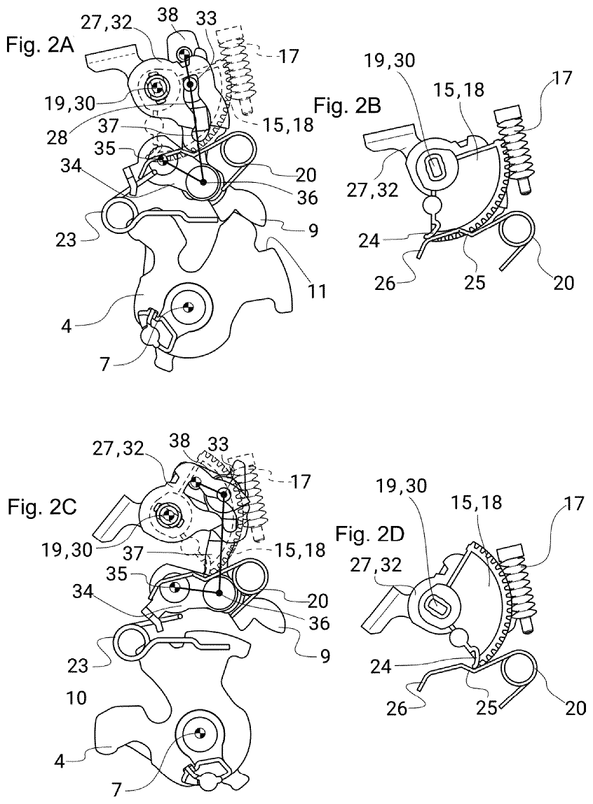

The exemplary embodiment shown in the figures and preferred in this respect relates to a motor vehicle lock 1 for a locking element 2 of a motor vehicle 3. Regarding the design of locking element 2, reference may be made to the introductory statements, wherein in the present case FIG. 1 shows the mode of operation of the motor vehicle lock 1 for the locking element 2 designed as a side door. However, all statements also apply to all other types of locking elements of the motor vehicle 3. FIGS. 2a, 2b, and 2c, 2d show the motor vehicle lock 1 in respective side views in different states to be explained below, whereby not all the components of the motor vehicle lock 1 shown in FIG. 1 are shown.

The motor vehicle lock 1 is equipped with a lock latch 4 and a pawl system 5. The lock latch 4 is adjustable to at least one locking position, in this embodiment, and preferably a main locking position (FIG. 2a), and optionally a pre-locking position, for holding engagement with a locking part 6, and to an open position (FIGS. 1a, 1b, 2c) for releasing the locking part 6, here preferably by pivoting about a geometric lock latch axis 7. The locking part 6 may be a locking bracket, a locking bolt, or the like. As can be seen in FIG. 1b, when the lock latch 4 is in the open position, the locking part 6 can be inserted into a locking part receptacle 8 of the lock latch 4. In this embodiment, and preferably, the motor vehicle lock 1 is arranged on locking element 2, while the locking part 6 is arranged fixed to the body of the motor vehicle 3, wherein a reverse arrangement is conceivable.

Pawl system 5 interacting with the lock latch 4 can be brought into a catching state (FIG. 2a) and a lifting state (FIGS. 1a, 1b, 2c). In the catching state, pawl system 5 locks the lock latch 4, which is in the locking position, against an adjustment in the opening direction of the lock latch 4 via a pawl 9. The locking positions can be reached starting from the open position in FIG. 2c by pivoting the lock latch 4 clockwise, whereby the pawl 9 can reach a main catch 10 (main locking position; FIG. 2a) or pre-catch 11 (pre-locking position; not shown) of the lock latch 4 by catching in a locking engagement. In the lifting state, the pawl 9 releases lock latch 4 in its opening direction, so that lock latch 4 can be transferred to the open position, for example, by spring loading and/or by guiding out the locking part 6. In this embodiment, and preferably, lock latch 4 is acted upon by a lock latch spring 12, which also acts on the pawl 9, via a pivotable sensor lever 13.

An opening drive 14 is provided for lifting pawl system 5. Here, the opening drive 14 brings the pawl system 5 into the lifting state by means of a pivotable actuating element 15, by an electric drive motor 16 of the opening drive 14 pivoting the actuating element 15 in a lifting direction from an initial position into an end position. In FIG. 2a, the motor vehicle lock 1 is shown in the main locking state with the actuating element 15 in the initial position, with the actuating element 15 being partially covered by further components. For clarity, FIG. 2b shows the actuating element 15 in a separate illustration in the initial position. In FIG. 2c, the actuating element 15 is pivoted to the end position by means of the drive motor 16, whereby the pawl system 5 is transferred into the lifting state and the lock latch 4 can reach the open position. FIG. 2d in turn shows the actuating element 15 in a separate illustration in the end position.

The electric drive motor 16 is designed as a rotary electric motor, the drive movement of which is converted directly or indirectly into a pivoting movement of the actuating element 15. In this embodiment, and preferably, a gear designed as a worm gear 17 is provided, in which a worm 17 associated with the drive motor 16 is in meshing engagement with toothing of a toothed element 18 that is coupled to the pawl system 5.

In the embodiment shown and preferred in this respect, the actuating element 15 is formed by the toothed element 18 and is associated with the opening drive 14, in particular the gear. However, the actuating element 15 may also be a component of the pawl system 5. The decisive factor is that the pivoting of the actuating element 15 from the initial position (FIG. 2b) to the end position (FIG. 2d) by means of the drive motor 16 is causal for transferring the pawl system 5 to the lifting state. The actuating element 15 is pivoted about a geometric actuating element axis 19. The actuating element 15 may be coupled directly or indirectly to pawl 9. The lifting direction represents the pivoting direction of the actuating element 15 when pivoting from the initial position to the end position and corresponds to the counterclockwise direction in FIG. 2.

It is now essential that the actuating element 15 is associated with an actuating element spring 20, which spring-loads the actuating element 15 located in the initial position counter to the lifting direction, and which spring-loads the actuating element 15 located in the end position in the lifting direction.

Accordingly, the direction of the effect of the actuating element spring 20 on the actuating element 15 depends on the position in which the actuating element 15 is located. The actuating element spring 20 here preferably effects a direct spring load on the actuating element 15, which is to be understood as meaning that the actuating element spring 20 effects the spring load via a direct mechanical contact between the actuating element spring 20 and the actuating element 15.

Depending on the position of the actuating element 15, the actuating element spring 20 generates a clockwise spring load in the initial position shown in FIGS. 2a, 2b and a counterclockwise spring load in the end position shown in FIG. 2 c, 2d.

It is particularly preferred that, in the end position, the actuating element 15 holds the pawl system 5 in the lifting state via the spring load of the actuating element spring 20. Releasing pawl system 5 to return to the catching state requires the actuating element 15 to leave the end position.

In the end position, the actuating element spring 20 introduces a torque into the actuating element 15, which prevents the pawl system 5 from being transferred to the catching state. The spring load in the end position is preferably selected such that, when the drive motor 16 is de-energized, the pawl system 5 remains in the lifting state. Leaving the end position of the actuating element 15 and thus releasing the pawl system 5 requires the application of a counter torque to the actuating element 15 to overcome the spring load. For this purpose, the drive motor 16 can preferably be reversed to pivot the actuating element 15 from the end position into the initial position.

Furthermore, in this embodiment, and preferably it is provided that the actuating element 15 is associated with an initial stop 21 for the initial position, against which the actuating element spring 20 holds the actuating element 15 in abutment in the initial position, and/or that the actuating element 15 is associated with an end stop 22 for the end position, against which the actuating element spring 20 holds the actuating element 15 in abutment in the end position.

The initial stop 21 and/or the end stop 22 are mechanical limits for the pivoting angle of the actuating element 15, which, in this embodiment and preferably, have an elastic buffer material to reduce noise development when the respective position is reached. The spring load holds the actuating element 15 in abutment with the initial stop 21 or end stop 22, respectively, so that the respective position is precisely defined and noise development caused by rattling of the actuating element 15 during driving operation or the like is avoided.

In a particularly preferred embodiment, it is provided that the actuating element 15 is additionally indirectly spring-loaded into the initial position via a spring-loaded component mechanically coupled to the actuating element 15.

An indirect spring load means that the spring load of another, directly spring-loaded component acts on the actuating element 15 through the mechanical coupling. In this embodiment, and preferably, pawl system 5 is spring-loaded in the direction of the catching state via a return spring 23. Due to the mechanical coupling between the actuating element 15 and the pawl system 5, which is provided for lifting the pawl system 5, the return spring 23 causes an indirect spring load of the actuating element 15 into the initial position.

The proposed design of the actuating element spring 20 is particularly advantageous in this regard. The mechanical coupling, which causes the indirect spring load, may, for example, be subject to play, so that it is not entirely sufficient for effective rattle protection in the initial position. Accordingly, the actuating element spring 20 can serve to suppress noise in the initial position, by securing the abutment at the initial stop 21.

Particularly preferably it is provided that the spring load of the actuating element spring 20 holds the actuating element 15 in the end position against the indirect spring load. Consequently, pawl system 5 can be held via the actuating element spring 20, even under indirect spring load. Holding against the indirect spring load can be achieved by adjusting the torque exerted on the actuating element 15 via the actuating element spring 20, which torque, in the end position, exceeds the torque exerted on the actuating element 15 by the indirect spring load.

It may be provided that the amounts of torque exerted on the actuating element 15 via the actuating element spring 20 are different in the initial position and the end position. The torques can be adjusted independently of each other, in particular with regard to the respective function (e.g. rattle protection of the actuating element 15 in the initial position, holding the pawl system 5 in the end position).

Preferably, the amount of torque exerted on the actuating element 15 via the actuating element spring 20 in the initial position is smaller than the amount of torque exerted on the actuating element 15 via the actuating element spring 20 in the end position. This allows for the fact that an indirect spring load of the actuating element 15 against the lifting direction, for example, via the return spring 23, tends to support the actuating element spring 20 in the initial position and acts against the actuating element spring 20 in the end position.

Furthermore, in this embodiment, and preferably it is provided that the actuating element spring 20 has a spring section, which acts elastically against a contact element 24 of the actuating element 15, and that the spring section in a first adjustment range from the initial position to an intermediate position spring-loads the contact element 24 with an effect counter to the lifting direction and in a second adjustment range from the intermediate position to the end position with an effect in the lifting direction.

In this embodiment, contact element 24 has a contact contour to which the actuating element spring 20 with the spring section is in direct abutment over the adjustment range from the initial position to the end position. The torque exerted by the actuating element spring 20 on the actuating element 15 via the contact element 24 varies with the position of the actuating element 15 by the actuating element spring 20 with the spring section having different contact points to the contact contour.

In the initial position, the contact force effected by the actuating element spring 20 runs along the actuating element axis 19 past the contact contour (left of the actuating element axis 19 in FIG. 2b) in such a way that the torque acts against the lifting direction. This effect of the contact force preferably remains until pivoting to the intermediate position (not shown), in which the contact force runs approximately through the actuating element axis 19. When pivoting further in the lifting direction up to the end position, the contact force runs along the actuating element axis 19 (to the right of the actuating element axis 19 in FIG. 2 d)) in such a way that the torque acts in the lifting direction.

Furthermore, in this embodiment, and preferably it is preferably shown that the actuating element spring 20 is designed as a leg spring and that the spring section is formed by a spring leg of the actuating element spring 20. Accordingly, the functionality of the actuating element spring 20 can be implemented by a one-sided spring load of the actuating element 15. As further shown in FIG. 2 b), d), it is preferably provided that the spring section has a catching bevel 25 which, in the end position, spring-loads the contact element 24 with an effect in the lifting direction. Furthermore, the catching bevel 25 can be formed by angling the spring section relative to a direction in which the spring section otherwise extends. By selecting the length and orientation of the catching bevel 25, the torque in the end position caused by the actuating element spring 20 can be easily adjusted.

Preferably, according to a further embodiment, it is provided that the spring section is otherwise shaped in a straight line, whereby in particular the spring load in the initial position can be adjusted via the preload of the actuating element spring 20. According to the embodiment shown in FIG. 2, the spring leg has an insertion bevel 26 adjacent to the spring section, which, however, does not come into contact with the contact element 24 and can, for example, facilitate the installation of the actuating element spring 20.

However, in a further embodiment (not shown), the insertion bevel 26 in the initial position can cause the spring load in the initial position, wherein in turn the length and orientation of the insertion bevel 26 can be used to adjust the spring load in the initial position.

In this embodiment, and preferably, the spring section continuously comes into contact with the contact element 24 over the adjustment path from the initial position to the end position. In a further embodiment (also not shown) the spring section can be interrupted. For example, the actuating element spring 20 is out of contact with the contact element 24 over a section of the adjustment path between the initial position and the end position.

According to a further embodiment (not shown), an actuating element spring 20 designed as a toggle spring can also be used, the direction of action of which can be reversed with the pivoting of the actuating element 15.

Furthermore, in this embodiment, and preferably it is provided that a pivotable release lever 27 is provided with a release contour 28, and that the release contour 28, in the course of pivoting the actuating element 15, guides a coupling arrangement 29 of the pawl system 5 such that the pawl system 5 is adjusted from the catching state into the lifting state.

The release lever 27 can be pivoted about a geometric release lever axis 30 by means of the drive motor 16 to transfer the pawl system 5 into the lifting state. The pivoting of the release lever 27 can also be affected manually, for example, via an actuating lever, wherein the actuating lever can be mechanically coupled to an operating element, such as a door handle 31, of the locking element 2 in the assembled state of the motor vehicle lock 1.

In this embodiment, the release contour 28 is preferably formed by a recess in the release lever 27, in which the coupling arrangement 29 runs. The release contour 28 is designed eccentrically to the release lever axis 30, so that when the release lever 27 is pivoted, the coupling arrangement 29 and thus the pawl system 5 are adjusted.

Preferably, the release lever 27 is coupled to the actuating element 15 in a rotationally fixed manner. When the actuating element 15 is pivoted, the release lever 27 is also pivoted accordingly. In a further embodiment (not shown), the release lever 27 is formed by the actuating element 15.

Furthermore, in this embodiment, and preferably it is provided that the pawl system 5 has a locking element 32, that the locking element 32 locks the pawl system 5 in a locking position against being transferred into the lifting state, and that the locking element 32, in the course of the pivoting of the actuating element 15, moves into a release position in which the locking element 32 releases the pawl system 5 into the lifting state.

Preferably, the locking element 32 is formed by the release lever 27. In particular, a locking contour 33 may be provided, for example, by the recess on the release lever 27, which, in the locking state, prevents the pawl system 5 from being transferred to the release state via the coupling arrangement 29. In this embodiment, and preferably, the locking state is assumed with the actuating element 15 in the initial position (FIG. 2 a)). When the locking element 32 is pivoted from the initial position, and thus also the release lever 27, the locking pawl system 5 is released.

Furthermore, in this embodiment, and preferably it is provided that the pawl system 5 has a pivotable pawl lever 34 on which the pawl 9 is pivotally mounted and which can be pivoted by means of the opening drive 14 from a normal position, in which the pawl 9 can be transferred into locking engagement with the lock latch 4, into a deflected position in which the pawl 9 releases the lock latch 4, and that, in the end position, the actuating element 15 holds the pawl lever 34 in the deflected position via the spring load of the actuating element spring 20.

The pawl lever 34 is pivotable about a geometric pawl lever axis 35. The normal position is assumed in the main locking state, preferably also in the pre-locking state, and here corresponds to a specific angular position of the pawl lever 34 about the pawl lever axis 35. The normal position is shown in FIGS. 1 and 2a. The normal position can be resumed after an opening operation, wherein, in this embodiment, the lock latch 4 is in the open position, as shown in FIG. 1. The pivotally mounted pawl 9 can be lifted out (FIG. 1) and can catch again when the lock latch 4 is locked again by inserting the locking part 6 (FIG. 2a).

Preferably, the pawl lever 34 is spring-loaded in the direction of the normal position, in particular by means of the already mentioned return spring 23. The indirect spring load of the actuating element 15 can be attributed to the pawl lever 34.

The pawl 9 and the pawl lever 34 can form a first toggle lever arrangement, which bends around the pawl bearing 36 acting as the first toggle joint as it is transferred to the lifting state. During the opening actuation, the release lever 27 can adjust the pawl lever 34 via an intermediate lever 37. The intermediate lever 37 can form a second toggle lever arrangement with a pivotally mounted coupling lever 38, which bends as the opening actuation occurs. The coupling arrangement 29 may be arranged on a second toggle joint of the second toggle lever arrangement. In this embodiment, the coupling lever 38 and the intermediate lever 37 are connected to one another via the second toggle joint, wherein the coupling arrangement 29 is preferably arranged on the second toggle joint. In this embodiment, and preferably, the intermediate lever 37 engages the pawl bearing 36 on the pawl lever 34.

Furthermore, in this embodiment, and preferably it is provided that the opening drive 14 pivots the actuating element 15 into the end position when a holding condition is met and leaves it there. The opening drive 14 can in principle cause the actuating element 15 to pivot to the end position, but normally the actuating element 15 can then be reset by motor by reversing. If the holding condition is met, the opening drive 14 leaves the actuating element 15 in the end position. This is preferably achieved by de-energizing the drive motor 16 when the actuating element 15 is in the end position.

Particularly preferably it is provided that the stopping condition occurs in an emergency operation. Examples of emergency operation include a failure of an on-board electrical system, for example due to a central battery being largely discharged or a failure of electrical wires in the on-board electrical system, and a crash event of the motor vehicle 3, whereby a normal electrical supply voltage may not be sufficiently available to control the opening drive 14. By holding the locking pawl 9, a lock-in state can be safely prevented.

In a further embodiment, it is provided that the holding condition occurs before lock latch 4 reaches an open position. Only when the open position is reached and/or after a predetermined period of time has elapsed can the actuating element 15 be reset. If the lock latch 4 is not moved into the open position after the pawl 9 has been lifted, for example, due to a snow load on the locking element 2 or due to icing, the operator is thus able to open the locking element 2 manually without the opening drive 14 having to be triggered again.

Furthermore, in this embodiment, and preferably it is provided that a control arrangement for controlling the opening drive 14 with an electrical energy storage device for supplying the opening drive 14 in emergency operation is provided. The control arrangement is designed to map the description of the functions of the opening drive 14 in terms of control technology. In addition to or instead of the design with a control arrangement integrated into the motor vehicle lock 1, such as within a lock housing 39, it is conceivable that the control arrangement is part of a separate control unit 40 for the motor vehicle lock 1. Examples of such a control unit 40 are a flap control unit and a door control unit, which can also perform further electronic functions in the locking element 2.

In a particularly preferred embodiment, the control arrangement is provided with an electrical energy storage device for supplying the opening drive 14 in emergency operation. In emergency operation, discharging the energy storage unit is used to supply the opening drive 14 with electrical energy. For example, the control arrangement is equipped with at least one capacitor, such as at least one double-layer capacitor, and/or with a primary cell, whereby a power supply to the opening drive 14 can be ensured.

The holding condition can occur with an opening movement effected via the opening drive 14 in emergency operation, after performing a predetermined number of opening movements in emergency operation and/or when the energy storage device falls below a predetermined minimum charge state. This in turn means that a locked-in state can be reliably prevented even when using the energy storage unit.

1. A motor vehicle lock with a lock latch and with a pawl system, wherein the lock latch can be adjusted into a closed position for the holding engagement with a locking part and into an open position for releasing the locking part, wherein, in a catching state, the pawl system locks the lock latch located in the closed position via a pawl against an adjustment in its opening direction and releases it in a lifting state, wherein an opening drive is provided, which brings the pawl system into the lifting state by means of a pivotable actuating element, by an electric drive motor of the opening drive pivoting the actuating element in a lifting direction from an initial position to an end position, wherein the actuating element is associated with an actuating element spring, which spring-loads the actuating element located in the initial position counter to the lifting direction, and which spring-loads the actuating element located in the end position in the lifting direction.

2. The motor vehicle lock according to claim 1, wherein, in the end position, the actuating element holds the pawl system in the lifting state via the spring load of the actuating element spring.

3. The motor vehicle lock according to claim 1, wherein the actuating element is associated with an initial stop for the initial position, against which the actuating element spring holds the actuating element in abutment in the initial position, and/or wherein the actuating element is associated with an end stop for the end position, against which the actuating element spring holds the actuating element in abutment in the end position.

4. The motor vehicle lock according to claim 1, wherein the actuating element is additionally indirectly spring-loaded into the initial position via a spring-loaded component mechanically coupled to the actuating element, preferably wherein, in the end position, the spring load of the actuating element spring holds the actuating element counter to the indirect spring load.

5. The motor vehicle lock according to claim 1, wherein the amounts of the torque exerted on the actuating element via the actuating element spring are different in the initial position and the end position, preferably wherein the amount of the torque exerted on the actuating element via the actuating element spring in the initial position is smaller than the amount of the torque exerted on the actuating element via the actuating element spring in the end position.

6. The motor vehicle lock according to claim 1, wherein the actuating element spring has a spring section, which acts elastically against a contact element of the actuating element, and wherein the spring section spring-loads the contact element in a first adjustment range from the initial position to an intermediate position with an effect counter to the lifting direction and in a second adjustment range from the intermediate position to the end position with effect in the lifting direction.

7. The motor vehicle lock according to claim 6, wherein the actuating element spring is designed as a leg spring, and wherein the spring section is formed by a spring leg of the actuating element spring, preferably wherein the spring section has a catching bevel, which, in the end position, spring-loads the contact element with effect in the lifting direction, further preferably wherein the spring section is otherwise shaped in a straight line.

8. The motor vehicle lock according to claim 1, wherein a pivotable release lever with a release contour is provided, wherein the release contour guides a coupling arrangement of the pawl system in the course of pivoting of the actuating element in such a way that the pawl system is adjusted from the catching state to the lifting state, preferably wherein the release lever is coupled to the actuating element in a rotationally fixed manner or the release lever is formed by the actuating element.

9. The motor vehicle lock according to claim 1, wherein the pawl system has a locking element, wherein, in a locking position, the locking element locks the pawl system against being transferred into the lifting state, wherein the locking element, in the course of the pivoting of the actuating element, transitions into the release position in which the locking element releases the pawl system into the lifting state, preferably wherein the locking element is formed by the release lever.

10. The motor vehicle lock according to claim 1, wherein the pawl system has a pivotable pawl lever on which the pawl is pivotally mounted and which can be pivoted by means of the opening drive from a normal position, in which the pawl can be transferred into locking engagement with the lock latch, into a deflected position in which the pawl releases the lock latch, and wherein, in the end position, the actuating element holds the pawl lever in the deflected position via the spring load of the actuating element spring, preferably wherein the pawl lever is spring-loaded in the direction of the normal position.

11. The motor vehicle lock according to claim 1, wherein the opening drive pivots the actuating element into the end position when a holding condition is met and leaves it there, preferably wherein the holding condition occurs in an emergency operation, in particular in the event of a failure of a normal supply voltage for the motor vehicle lock, and/or wherein the holding condition occurs before an open position of the lock latch is reached.

12. The motor vehicle lock according to claim 11, wherein a control arrangement for controlling the opening drive with an electrical energy storage device for supplying the opening drive in emergency operation is provided, and wherein the holding condition occurs with an opening movement effected via the opening drive in emergency operation, in particular after carrying out a predetermined number of opening movements in emergency operation and/or when the energy storage device falls below a predetermined minimum charge state.

13. The motor vehicle lock according to claim 2, wherein the actuating element is associated with an initial stop for the initial position, against which the actuating element spring holds the actuating element in abutment in the initial position, and/or wherein the actuating element is associated with an end stop for the end position, against which the actuating element spring holds the actuating element in abutment in the end position.
